(19) United States
(12) Patent Application Publication
(10) Pub. No.: US 2005/0041534 A1
(43) Pub. Date: Feb. 24, 2005

(54) Timer with multiple and personalized audio indicators

(76) Inventor: Maria E. McCarthy, San Quentin, CA (US)

Correspondence Address: LITMAN LAW OFFICES, LTD., P.O. BOX 15035 CRYSTAL CITY STATION, ARLINGTON, VA, 22215, US

(21) Appl. No.: 10/643,894

(22) Filed: Aug. 20, 2003

(51) Int. Cl. G04F 8/00; G04F 10/00

(52) U.S. Cl. 368/109

(57) ABSTRACT

The timer with multiple and personalized audio indicators is a programmable interval timer for selecting a time interval within a user determined longer time block, the timer signaling the end of the interval duration with an audible sound and then reinitializing the countdown timer interval for as many whole number intervals as will fit in the time block. The audible signal generated upon each counted down interval is selected from a plurality of audible sounds stored within the timer and automatically indexed to the next sound upon generation. The timer consists of a base housing, timer circuitry, audio circuitry and an interchangeable faceplate, the faceplate having decorative indicia and a memory device within which a plurality of sounds is electronically stored representative of the indicia disposed on the faceplate.

### BACKGROUND OF THE INVENTION

1. Field of the Invention

The present invention relates to timers, and specifically to timers with programmable intervals and means for generating different sounds upon completion of an interval.

2. Description of the Related Art

Timers that prompt the user to perform a certain activity at a scheduled time are well known in the art. The well known “kitchen timer” is one of a number of mechanical timers that produce an audible tone after a predetermined period. Timers are prevalent in the field of education, both as an instructional tool in the subject of time, as well as a functional tool for time management of classroom activities. In both instances, the intended goal is to provide an audible signal that, at a minimum, will break through the child's consciousness and, more optimistically, motivate the child to further action.

With advances in technology, electronic timers now offer a wide range of programmable options which were previously unavailable in older mechanical devices. U.S. patent application Ser. No. 2002/0009018, published in January 2002, discloses a timer device for conditioning children to perform special tasks, and includes a generated signal controlled by a Central Processing Unit (CPU), which acts to, among other things, establish normal time intervals so that the signal is activated at the end of that interval. A voice acknowledgment message, recorded by a microphone, is activated by a switch operated by the child upon completion of the timed task.

U.S. Pat. No. 3,591,956, issued to J. Draghi in July 1971, discloses a mechanical timer having an audible signal at various intervals in a run-out or run-down cycle. The output is prevented if the mainspring is not fully wound.

U.S. Pat. No. 5,044,961, issued to E. Bruskewitz in September 1991, discloses a child activity timer for teaching young children the concept of time. The timer in the '961 patent is a one time run-out timer comprising a housing containing a mechanical or electronic timing mechanism and activity selector. The timer permits selection of a duration of predetermined length and includes an indicator that moves in relation to a time scale to graphically illustrate the change in duration of time.

An electronic interval timer disclosed in U.S. Pat. No. 5,253,228, issued to B. Truett in October 1993, discloses a cylindrical shell having five rows of light emitting diodes (LEDs) mounted at spaced intervals from top to bottom. Timer and control circuits are connected to select a desired time interval, to illuminate the LEDs, and to turn off successive rows in proportion to the time remaining in the selected interval. Interrupt and rest capabilities are provided along with a buzzer or voice chip which provides a single, non-unique audible signal when the interval has run out.

Many of the aforementioned devices feature advanced time functions only available with the incorporation computer chips. However there is much room for improvement in a timer interval providing a variety of audio signals that would maintain the interest of a child. None of the above inventions and patents, taken either singly or in combination, is seen to describe the instant invention as claimed. Thus a timer with multiple personalized audio features solving the aforementioned problems is desired.

### SUMMARY OF THE INVENTION

The timer with multiple and personalized audio indicators is a programmable interval timer for selecting a countdown time interval within a user determined longer time block, the timer signaling the completion of the interval with one of a plurality of predetermined sounds, or with a personalized sound recorded by an integrated microphone. The countdown timer interval is reinitialized automatically. The audible signal is generated from a plurality of audible sounds stored within the timer and automatically indexed to the next sound upon the signaling of each repeated interval. The timer consists of a housing, timer circuitry, audio circuitry and an interchangeable faceplate, the faceplate having decorative indicia and a memory device within which a plurality of sounds are electronically stored and are audibly representative of the unique indicia disposed on the faceplate.

Accordingly, it is a principal object of the invention to provide an interval timer with multiple and personalized audio indicators having the capability of indexing through a selection of electronically stored sounds upon completion of the selected time interval.

It is another object of the invention to provide an interval timer deriving its audible signals from a memory device disposed within an interchangeable faceplate.

Still another object of the invention is to provide an interval timer with multiple and personalized audio indicators having a microphone with which to record an audible signal generated at completion of at least one of the countdown intervals.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front elevation view of a timer with multiple and personalized audio indicators according to the present invention.

FIG. 2A is an exploded perspective view of the present invention according to FIG. 1.

FIG. 2B is a side view of the memory device with stored interval audio indicators mounted on the rear of the faceplate, removably received by the socket on the printed circuit board mounted on the timer housing.

FIG. 3 is a representative block diagram of the timer of FIG. 1.

FIG. 4 is an alternative embodiment of the decorative faceplate having indicia representative of the Serengeti.

Similar reference characters denote corresponding features consistently throughout the attached drawings.

### DETAILED DESCRIPTION OF THE PREFERRED EMBODIMENTS

The present invention is a timer with multiple and personalized audio indicators, designated generally as 100 in the drawings.

The timer 100 is a programmable interval timer that enables teachers to manage cooperative groups of students more effectively, and that incorporates an assortment of predetermined audio sounds, as well as user recorded audio sounds, that are generated at the end of a user selected time interval, the interval being repeatedly counted down within an initial block of time set by the user.

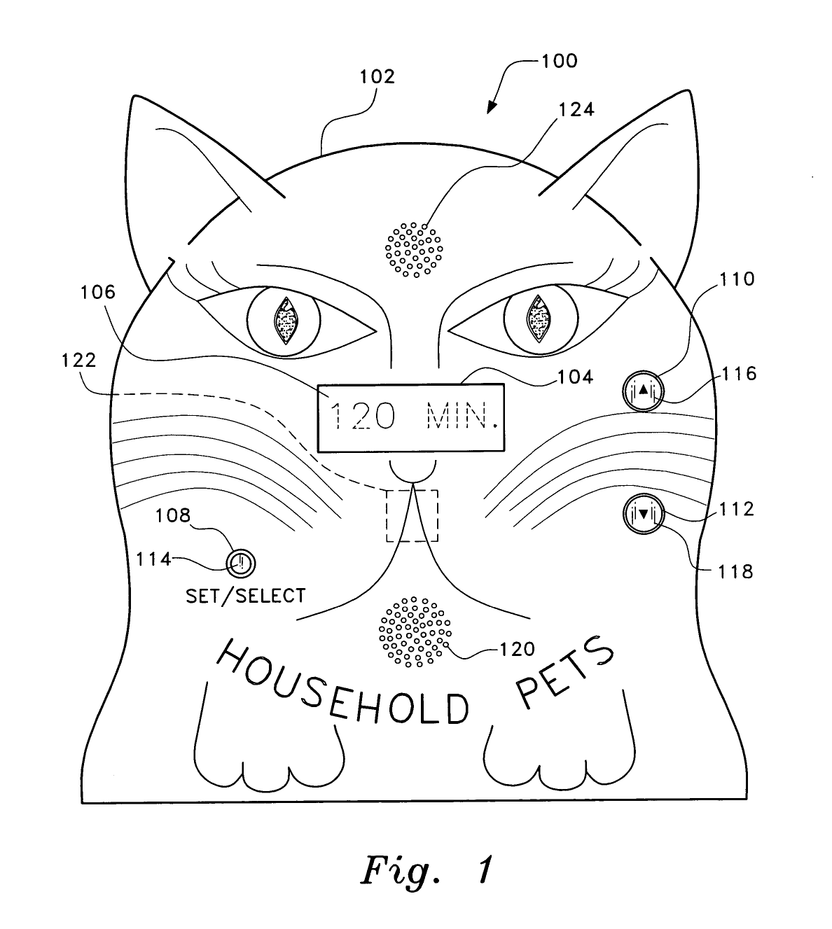

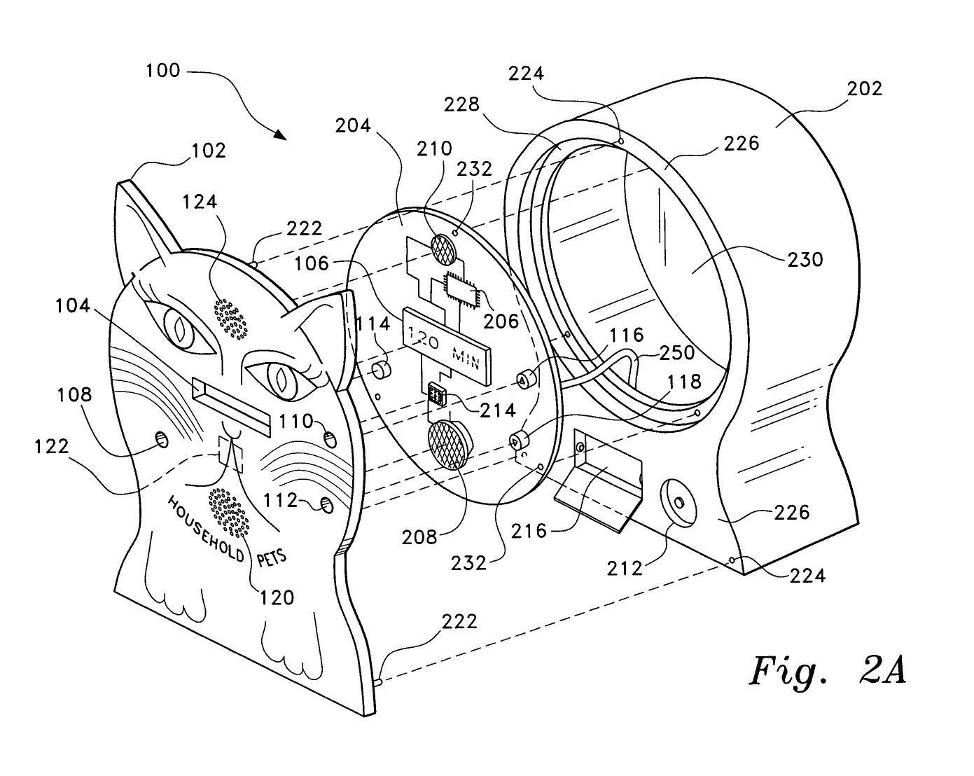

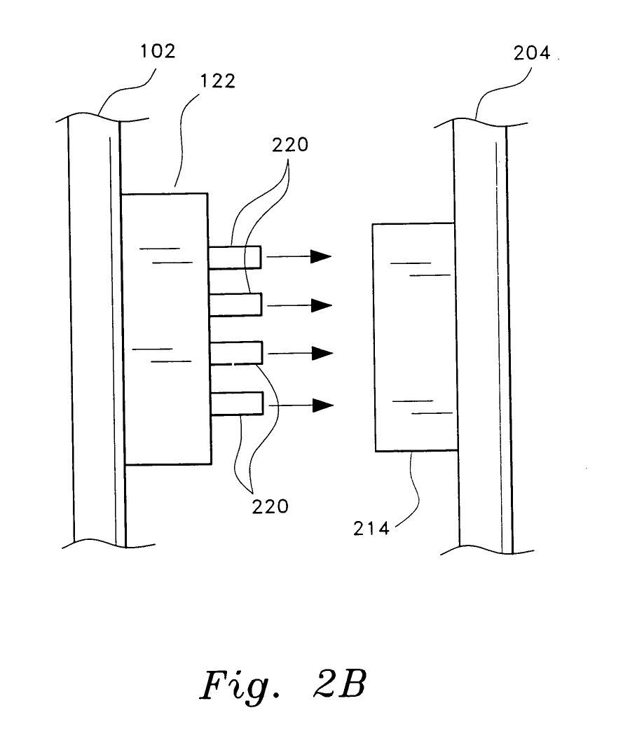

As shown in FIGS. 1 and 2A, the timer 100 is comprised of a faceplate 102 mounted to a molded plastic housing 202 and held in place by plastic fasteners 222 received by mounting holes 224. The housing 202 has an interior cavity 230, a circuit board 204 disposed in a cavity 230 defined within the housing 202 containing timer and audio circuitry, and two battery compartments 212, 216 defined within the housing 202.

The timer 100 has been designed for use in early childhood education and therefore has been specifically structured to gain the attention of young children. The faceplate 102 has decorative indicia disposed thereon and contains an electronic memory device 122 attached to the rear of the faceplate 102. Electronically stored within the memory device 122 is a plurality of sounds, recorded or synthesized, characteristic of the design on the front of the faceplate. As best shown in FIG. 2B, the terminals 220 of memory device 122 are received by memory socket 214 forming part of the circuitry disposed on printed circuit board 204, whereby mounting a different faceplate upon the housing 202 operates to insert a corresponding memory device 122 into the logic of the timer 100, thereby adapting the interval indicator messages to the faceplate motif.

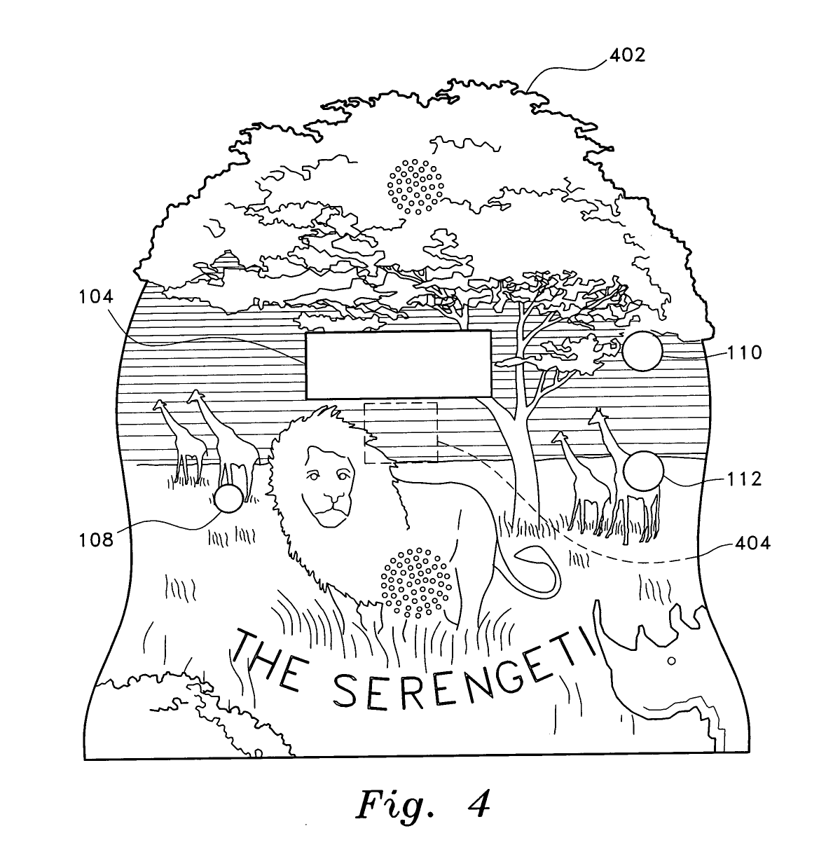

As shown in FIG. 1, faceplate 102 may represent a household pet, such as a cat, with sounds of the corresponding household pet stored on memory chip 122. In contrast, FIG. 4 has faceplate 402 representative of the Serengeti, and has a memory chip 404 containing sounds from the African plains. Timer 100 may be packaged as a kit with an assortment of interchangeable faceplates, each faceplate having a different motif and corresponding memory chip 122 storing assortment of sounds representative of the specific faceplate.

The faceplate 102, 402 is made of plastic and has apertures defined therein, through which timer controls, disposed on the underlying printed circuit board 204 are made available. An alphanumeric display 106, mounted on printed circuit board 204, is visible through cutout 104 in faceplate 102, and facilitates the setup of the timer 100 through a computer generated menu. Furthermore, the display 106 presents a visual indication of the time remaining in the selected time block and in the current countdown interval, thereby providing the child not only with an interesting sound generating device, but also a device that may serve in the teaching of the concept of time.

Menu navigation is enabled by means of up and down scroll buttons 116, 118 and button 114 selects a desired function. Apertures 110, 112 and 108 make these controls accessible through faceplate 102. The audible signals generated at the completion of each interval emanate from within the housing 202 and pass through a grid of small openings 120 disposed on the faceplate 102. In the same manner, the internal microphone 210, which may be mounted on the printed circuit board 204 behind the openings 124 disposed on the faceplate 102, receives the speech to be used as personalized interval messages.

As shown in FIG. 2A, the printed circuit board 204 is secured to a recessed ledge 228, by means of screws or other fasteners inserted through mounting holes 232. A power harness 250 connected to battery compartments 212, 216 provides power to the timer and audio logic disposed on the printed circuit board 204. Although one battery may be sufficient to provide an operative voltage to both the digital timer circuitry and the audio circuitry, alternatively a second battery may be utilized to enable the timer logic to be powered from one battery while a separate battery drives the audio logic, the audio logic generating and amplifying the analog wave shapes necessary to drive speaker 208.

The speaker 208 may be mounted directly to the printed circuit board 204 and depending upon the depth of the speaker, the back of the speaker may extend into cavity 230 of the housing 202. The timer 100 includes a microphone 210, which like the speaker 208, may be mounted to the printed circuit board 204, the microphone 210 providing the means by which personalized interval notification messages may be stored within the logic of the timer 100.

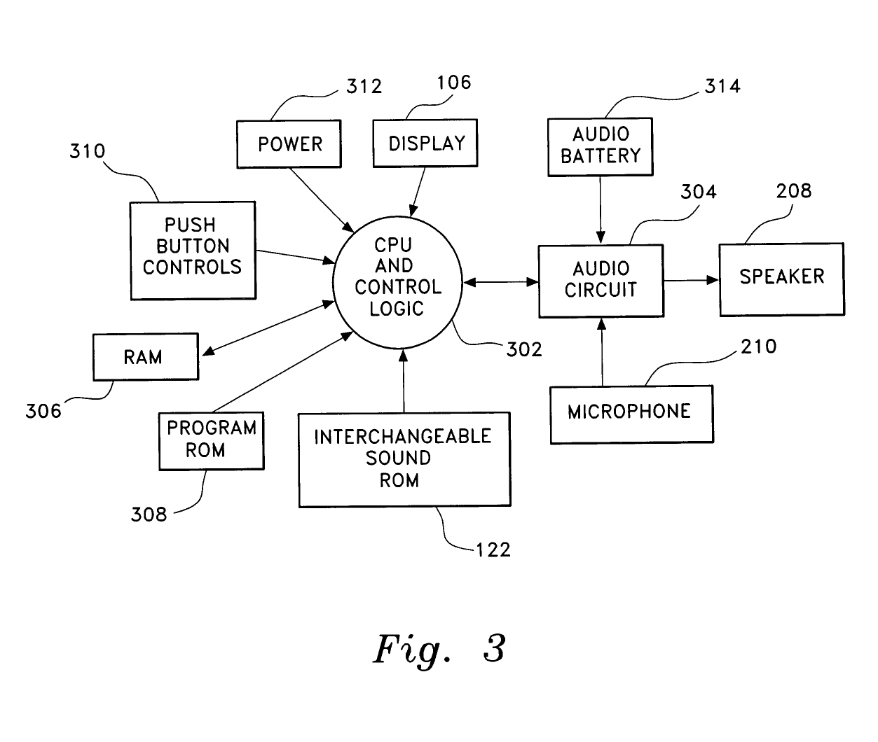

As shown in the block diagram of FIG. 3, the operation of timer 100 is controlled by a central processing unit (CPU) 302 mounted on the printed circuit board 204. The timer includes: program memory 308 which may be read only memory (ROM); random access memory (RAM) 306; a display unit 106; an interchangeable memory device 122 that electronically stores the sounds to be generated at the termination of each programmed time interval; push button controls 310 for setting selecting menu options; and an audio circuit 304 for transforming digital signals to an analog waveform and amplifying the resultant waveform through speaker 208. As previously mentioned, a microphone 210 enables the user to program the timer with personalized messages to be played at the conclusion of one or multiple intervals.

The timer 100 may have an on/off switch, however, no switch is needed or is present in the preferred embodiment. Insertion of the battery for power 312 for the CPU and 302 and memory circuits and the audio battery 314 for driving the audio circuits into their respective compartments, and insertion of a sound memory device 122 is sufficient to reset the logic.

The timer logic recognizes the presence of the sound memory device 122 and may either transfer the electronic representation of these sounds to a RAM memory device 306 on the printed circuit board 204, or may be so designed as to read the sounds directly from the external memory chip 122 as required. Once power is applied to the timer circuitry, or when the sound memory device 122 is inserted, as when a faceplate 102 is interchanged, the timer 100 is in standby mode and awaits manual commands entered by the control pushbuttons 310. The pushbuttons consist primarily of scroll command buttons 116, 118 and function selection button 114.

The alphanumeric display 106 may consist of a liquid crystal display (LCD) device displaying a single line of text and numbers and, as previously disclosed, is used to facilitate setting of the block of time within which repeated intervals of a shorter period is set. An initial depression of the selection pushbutton 114 puts the timer 100 in menu select mode, at which point the user may select one of several functions: (a) select the larger block of time which may be then subdivided into smaller time intervals; (b) select the smaller time interval; (c) replace an interval notification indication with a personalized message recorded by the microphone 210; (d) initiate the countdown of the interval; or (e) perform a reset of the timer.

As known to those skilled in the art, the combination of a computer chip, a memory, and a display offers endless possibilities in programmable time functions, and the present invention is not limiting itself to any single embodiment. Once initiated, the display 106 may display the current time, the time remaining of the initial block of time, the remaining time of the current interval, or any combination of the above, either sequentially indexed, or by manual selection.

Scrolling menus and up/down buttons are not new. However the ability to set the length of time for the block as well as the interval in individual minute gradations is a feature, which provides a user with a level of control heretofore unknown. For example, a teacher may set the timer 100 for a one hour classroom instructional period, then set the timer 100 to sound different alarms (animal sounds or voice messages) at ten minute intervals.

Furthermore, an interval timer 100 with the capability of generating a different audible indication signal upon each successive counting down of the interval provides an educator with a tool that may retain the interest of the students. Interchangeable faceplates 102, 402 with different motifs and assortment of sounds add a further dimension to the device which extends the lifetime of the timer 100 once students are bored with the current selection. The choice of motif is limited only by imagination and may include: musical instruments, the rainforest, geography, history, questions related to mathematics, and super hero voices to name just a few.

A memory device 122 storing at least 12 different messages would suffice to provide a different audible alert for multiple ten-minute intervals within a 120-minute block of time. Furthermore, the microphone 210 in conjunction with the CPU 206, program code and onboard RAM 306 allows a user to replace any alert message for any one of the intervals with a prerecorded and personalized message. After personalizing the interval completion messages, the original sounds, as stored on the memory device 122, are reset upon removal and reinsertion of the faceplate 102 or may be incorporated as a menu driven control.

It is to be understood that the present invention is not limited to the embodiment described above, but encompasses any and all embodiments within the scope of the following claims.

1. A timer with multiple and personalized audio indicators, comprising:
a housing having a base, a front surface, a rear surface, and side surfaces extending between the front surface and the rear surface, the housing defining a cavity, the front surface having an opening communicating with the cavity;
a faceplate having a front surface and rear surface, the faceplate being removably attached over the opening defined in the front surface of the housing;
first timer circuit means disposed within the cavity defined in the housing for repetitively counting down a first time interval and activating an audio signal each time the first time interval expires;
second timer circuit means disposed within the cavity defined in the housing for activating the first timer circuit means for a second time interval longer than the first time interval;
time selection means for programmably selecting a duration of the first and second time intervals;
a memory device having a plurality of sounds electronically stored within attached to the rear surface of the faceplate; and
audio circuit means for producing any of the electronic sounds stored in the memory device when the timer circuit means activates the audio signal.

2. The timer according to claim 1, wherein said first and second timer circuit means include a central processing unit, program memory, a display panel, timer control buttons, and computer readable program code means stored in the program memory, wherein the code means further comprising:
first instruction means for selecting the first time interval;
second instruction means for selecting the second time interval;
third instruction means for consecutively assigning each of said plurality of stored sounds to sequential first time intervals; and
fourth instruction means for requesting a sound to be generated by the audio circuit means upon completion of each time interval.

3. The timer according to claim 2, further comprising a microphone, and wherein the code means further comprises:
fifth instruction means for storing audible signals from said microphone and assigning said microphone generated audible signals to a user selected time interval;
sixth instruction means for resetting the audible signal to an initial state; and
seventh instruction means for displaying the time remaining in the time block and the time remaining in the time interval.

4. The timer according to claim 1, wherein said memory device has conductive terminals adapted to cooperatively engage said first and second timer circuit means, whereby mounting the faceplate to said housing electrically interconnects said memory device with said first and second timer circuit means, whereby the plurality of distinctive sounds stored on the memory device are accessible by said audio circuit means.

5. The timer according to claim 1, further comprising battery means for providing an operative voltage to said first and second timer circuit means and said audio circuit means.

6. The timer according to claim 5, wherein said battery means includes at least one pair of terminals adapted to receive at least one battery.

7. A method of setting an interval timer with multiple and personalized indicators, comprising the steps of:
selecting a block of time by means of an alphanumeric screen and control buttons, whereby the time block selected may be in gradients of one minute;
selecting a time interval shorter than the greater time block, the time interval being any number of user selected minutes;
automatically assigning each of a plurality of distinctive sounds to sequentially triggered time intervals; and
generating an audible signal upon completion of each time interval, fifth instruction means for storing audible signals from said microphone and assigning said microphone generated audible signals to a user selected interval.

8. The method of claim 7, further comprising the steps of:
resetting the timer circuitry means and reinitializing the sound indicators to their initial state prior to modification by the use of said microphone; and
displaying the time remaining in the time block and the time remaining in the time interval.

9. A method teaching young children the concept of time, comprising the steps of:
mounting an age appropriate faceplate with integrated sound memory device to a timer adapted to receive the faceplate;
selecting a block of time by means of an alphanumeric screen and control buttons, whereby the time block selected may be in gradients of one minute;
selecting a time interval shorter than the greater time block, the time interval being any number of user selected minutes;
generating an audible signal upon completion of each time interval, the audible signal automatically selected from the stored memory device; and
displaying the time remaining in the time block and the time remaining in the time interval.
